(19) United States
(12) Patent Application Publication
(10) Pub. No.: US 2025/0337814 A1
(43) Pub. Date: Oct. 30, 2025

(54) SYSTEMS AND METHODS FOR PEER-BASED INFLUENCE PREDICTION FOR COMPUTE ACTIONS

(71) Applicant: Wells Fargo Bank, N.A., San Francisco, CA (US)

(72) Inventors: Lakhan Khushalani, Charlotte, NC (US); Suganya Natarajan, Atlanta, GA (US); Anitra Griffin, Charlotte, NC (US)

(21) Appl. No.: 18/646,382

(22) Filed: Apr. 25, 2024

(51) Int. Cl. H04L 67/306

(52) U.S. Cl. CPC H04L 67/306

(57) ABSTRACT

Systems, apparatuses, methods, and computer program products are disclosed for peer-based influence prediction for compute actions. In various examples, a first subset of a first plurality of user accounts may be determined as peers for a first user account. A proposed compute action associated with the first user account may be identified. First encoded data representing the proposed compute action may be generated. A first similarity score may be generated based at least in part on the first encoded data and one or more encoded representations of past actions associated with the first subset of the first plurality of user accounts. An influence prediction may be generated for the proposed compute action based on the first similarity score. The influence prediction may indicate a predicted degree by which the proposed compute action is influenced by the past actions.

### BACKGROUND

Online activity may include a wide variety of actions that can be taken using a system of networked computing devices and/or computer-implemented services. Examples of online activity may include account registration, data storage, data streaming, interaction with web-based applications such as social media interaction and financial system interaction, etc. The online behavior of a given user may be influenced by a variety of factors including advertisements, the capabilities of various online services and/or websites, the actions of other users, etc.

### BRIEF SUMMARY

Users of online services may take a wide variety of compute actions. Some online compute actions, such as checking email, bank account balances, logging into a work account, etc., may be habitual actions for a user and may typically not be influenced by the behavior of others. However, in some cases, the decision to take a given compute action by a user may be influenced, consciously or subconsciously, by behavior of other users. For example, a decision to stream a particular movie, download a particular application, order a particular item from an e-commerce site, purchase a particular financial instrument, etc., may be influenced by a user's peers having taken the same or similar actions.

In some instances, it may be useful for a user to understand the degree to which their proposed compute actions may be influenced by others. For example, the knowledge that a proposed compute action may be highly influenced by the actions of a user's peers may provide useful perspective and/or context for the user and may enable the user to think more critically about the proposed compute action prior to execution. One example may be a proposed stock purchase that may be an unusual or uncharacteristic purchase for the user (e.g., a statistical outlier with respect to past stock purchases by the user), but where the purchase is highly similar to the purchases of others sharing the same (or a similar) demographic with the user (e.g., the user's peers). In some instances, trend data showing the influence prediction for a given user account's actions over time may be useful for the user and/or for other entities associated with the user account. For example, a financial advisor managing a user's account may be interested to learn the types of trades for which the user is highly influenced by the actions of the user's peers so that the financial advisor may take the best actions and/or provide the best advice for that user in the future.

Traditionally, there have not been technical solutions that are able to detect a peer group for a user and determine, for a given compute action proposed by the user, an influence exerted by the determined peer group on the proposed compute action. Currently, a user may second-guess a given compute action (e.g., downloading an application) prior to performing it. However, such introspection may not account for any subconscious influence that may be occurring. There currently does not exist a way to calculate and present a quantified and accurate peer-based influence prediction for a proposed compute action to a user in real time using observable, quantifiable signals.

Described herein are various computer-based techniques that provide this service. Example implementations use unsupervised machine learning to determine a peer group for a given user account based on observable signals. While peer group identification does exist, conventional techniques rely on potentially imprecise proxy metrics (such as social media connection status in isolation) that are not suitable for evaluating peer influence for particular proposed compute actions. In contrast, examples described herein quantify a user's peer group a proposed compute action for the user may be compared to compute actions taken by the user's peers to mathematically determine a degree of similarity and/or a distance (in the relevant feature space) between the proposed compute action and the actions taken by that user's peer group. Additionally, the various influence prediction techniques described herein may determine, for a given proposed compute action, whether the action is a statistical outlier with respect to previous compute actions taken by the user. In some examples, a supervised machine learning model may be trained to take the similarity score (describing the similarity of the proposed compute action with previous compute action taken by the user's peers) and an outlier score (describing the relative abnormality of the proposed compute action with respect to past compute actions taken by the user) as input to predict a degree of peer-based influence. In various cases, the user account may be selectively (e.g., programmatically) disabled from executing the proposed compute action until an acknowledgement of the predicted influence is received. In various further examples, different predicted influence thresholds may be used to trigger various displays, warnings, and/or actions for a proposed compute action (e.g., notifying an associated account, preventing the proposed compute action, etc.). The various influence prediction techniques discussed herein may enable users and/or associated accounts to better understand peer-based influence on prospective compute actions prior to execution and/or to develop computer-implemented logic that may take different actions depending on the predicted degree of peer-based influence.

According to some example embodiments described herein, an influence prediction engine may identify demographic data associated with a given user account, encode such demographic data, and employ one or more local or remote unsupervised clustering techniques to determine peer accounts (e.g., accounts having quantifiably similar demographic data). The influence prediction engine may identify a proposed compute action associated with the given user account. The influence prediction engine (and/or another component configured in communication with the influence prediction engine) may determine whether the proposed compute action is anomalous with respect to past compute actions taken by the user account (e.g., using statistical outlier detection) by comparing encoded representations of the proposed compute action with encoded representations of past compute actions taken by the user account. In various examples, proposed compute actions that are more dissimilar to past compute actions taken by the same account may be more likely to be influenced by peer groups. Additionally, the encoded representation of the proposed compute action may be compared (e.g., using a distance/similarity metric) to past compute actions taken by the peer group accounts to determine a degree of similarity (or dissimilarity) to the past compute actions of the peer group. A high degree of similarity to past actions of the peer group combined with a dissimilarity with respect to past actions of the user account may be a strong predictor of peer-based influence. In various examples, a machine learning model may assimilate a similarity score indicating the similarity to past compute actions of the peer group and an outlier score indicating a degree of similarity/dissimilarity with respect to past actions of the user account to predict an influence prediction score. The influence prediction score may be used to take various downstream actions, which may vary according to the desired implementation. For example, execution of the proposed compute action may be conditioned on the influence prediction score being below a threshold. In another example, the influence prediction score may trigger a notification to one or more other devices and/or accounts (e.g., a secondary device associated with the first user account, such as a device operated by a financial advisor and/or analyst associated with the user account). It should be noted that the specific downstream actions are implementation details that can vary according to the desired implementation.

The influence prediction engine and/or the various associated components described herein may be further incorporated with various entity systems (e.g., corporate networks, consumer banking databases, stock market data, inventory tracking systems, social media networks, etc.) so that the influence prediction engine may leverage (i) multimodal data to process compute action requests and/or determine relevant demographic data and/or peer groups, (ii) remote (e.g., cloud hosted, etc.) and/or localized (e.g., on-premises, integrated into the influence prediction engine, etc.) AI systems, and/or (iii) network and/or computing infrastructure for monitoring and securing sensitive data.

Accordingly, the present disclosure sets forth systems, methods, and apparatuses that provide improved systems and techniques for peer-based influence prediction for proposed compute actions. As an initial matter, because example implementations are solely computer-implemented, they offer solutions that generate peer-based influence predictions in real time (or at least near-real time), and which can therefore usefully guide user action. For many users, real time presentation of an influence prediction metric may guide or augment user behavior, whereas after-the-fact presentation of such a metric has little utility (the action has been taken). Accordingly, the computer implementation set forth herein offers a significant difference in kind from theoretical manual approaches for influence prediction that could not produce actionable results during a computing session in which a proposed compute action may be taken. In addition to increasing the utility of the generated influence prediction, there are many advantages that the computer-implemented solutions described herein offer over alternative systems.

One advantage is that example embodiments provide an improvement to the functioning of the computing infrastructure by selectively avoiding performance—and subsequent unwinding of—some proposed computing actions when peer-based influence is predicted to be high (e.g., above a threshold value). This can be due to programmatic disablement of execution of the proposed compute action or due to the user reconsidering the proposed compute action based on the influence prediction. Avoiding the need to undo prior actions avoids substantial utilization of hardware resources that would otherwise be deployed to rollback such compute actions.

Another advantage is that example embodiments disclosed herein provide a computational ability to predict peer-based influence when such influence may otherwise be undetectable (e.g., subconscious) by human intuition. Generating a quantitative prediction of peer-based influence using the systematic approach set forth herein therefore enables more accurate predictions of influence regarding proposed compute actions than would be generated via manual approaches, and may avoid undue processing and latency due to suboptimal compute action selection and/or execution.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for incorporating a peer-based influence prediction system.

FIG. 2 illustrates a schematic block diagram of example circuitry embodying an influence prediction engine that may perform various operations in accordance with some example embodiments described herein.

FIG. 3 illustrates an example of peer-based influence prediction techniques in accordance with some example embodiments described herein.

FIG. 4 illustrates an example flowchart for peer-based influence prediction in accordance with some example embodiments described herein.

FIG. 5 illustrates an example flowchart for generating an influence prediction using a similarity score and an outlier score in accordance with some example embodiments described herein.

FIG. 6 illustrates another example flowchart with additional details describing determining a peer group for a first user account in accordance with some example embodiments described herein.

FIGS. 7A-7B illustrate an example swim-lane diagram illustrating example operations for peer-based influence prediction in accordance with various examples described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application or service) hosted by a computing device that causes the computing device to operate as a server.

The term “Artificial Intelligence (AI) system” or “AI system” refers to any computing device, server, and/or computing network comprising one or more of a Generative Artificial Intelligence (GenAI) model, Large Language Model (LLM), artificial neural network, Machine Learning (ML) model, and/or any other computer system implementing algorithms, models and/or applications to make predictions or recommendations (as described herein).

The term “compute action” refers to any executable action that may be executed by one or more computing devices (and/or virtualized compute services), such as a network-connected computing device. A compute action may comprise one or more computer-executable instructions that may be executed by one or more processors of a computing device to take some action. A “proposed” compute action may refer to an action requested by a user account, but which may not yet have been executed. Examples of compute actions may include a request to send data from one system to another system, a request to execute code, a request to perform an action within an application (e.g., a request to navigate between webpages, a request to purchase a stock, a request to add a friend on social media, a request to initiate a download), etc.

The term “influence prediction” refers to a prediction of a degree to which some one or more compute actions are influenced by other actions and/or individuals, such as by actions that have occurred in the past. In various examples, the actions may be compute actions that may have been executed in the past. Data representations of such actions (e.g., encoded representations of previously executed compute actions) may be stored in non-transitory computer-readable memory.

The term “demographic data” as used herein refers to information about attributes of a particular account (e.g., geolocation data, age, occupation, date of birth, sex, place of residence, online status, group registration data, social media connections, etc.). It should be noted that any demographic data discussed herein may be used only with appropriate user permissions and that such permissions may be selectively withdrawn at any time, even if withdrawal of such information results in reduced or limited functionality.

The term “outlier” or “statistical outlier” as used herein refers to data points that differ significantly from other data points in a given distribution. An outlier may be defined using various thresholds (e.g., standard deviations) and may be detected using any of a variety of outlier detection techniques, such as, without limitation, Z-scores, interquartile range (IQR), Mahalanobis Distance, Density-based Spatial Clustering of Applications with Noise (DBSCAN), local outlier factor (LOF), support vector machines (SVMs), isolation forests, etc.

The term “clustering” as used herein refers to any of a class of unsupervised machine learning algorithms that divide unlabeled data or data points into different clusters such that more similar data points (along one or more shared dimensions of the data points) are included in the same cluster, while two data points that are highly different from one another may be included in different clusters. In general, a first data point within a first cluster may be included in the first cluster by a clustering algorithm if the first data point is more similar to other data points in the first cluster than the first data point is to any data point in a different cluster (or otherwise not included in the first cluster). Similarity, in the context of clustering, may be measured using any desired similarity or distance metric. Common examples include cosine similarity, Jaccard similarity, cosine distance, Euclidean distance, Manhattan distance, etc. Examples of clustering algorithms may include K means clustering, K-Mode clustering, K nearest neighbors (KNN), DBSCAN clustering, etc.

An “encoder” as used herein may refer to any system, circuit, and/or function that encodes input data into a numerical representation of that input data that can be used for downstream tasks (such as the clustering tasks performed by a clustering algorithm). For example, an encoder may generate a vector representing demographic data, where different elements of the vector (or different combinations of elements of the vector) represent a different demographic attribute and wherein the value of that element represents the value of that attribute. In a simple example, the first element of a vector may represent an age of a person. If the person is 24 years of age, the value of the first element of the vector may be 24. Other types of encoding performed by an encoder may include one-hot encoding, label encoding, count encoding, mean encoding, semantic encoding, etc.

### System Architecture

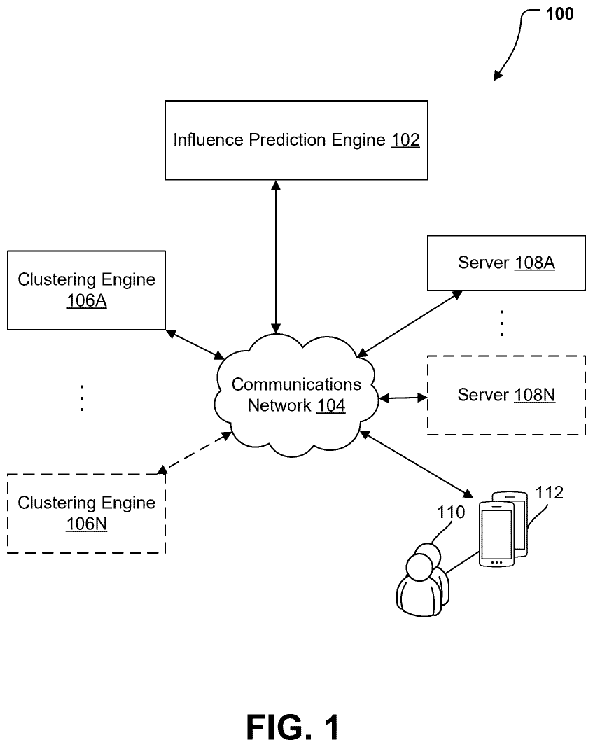

Example embodiments described herein may be implemented using any of a variety of computing devices or servers. To this end, FIG. 1 illustrates an example environment 100 within which various embodiments may operate. As illustrated, an influence prediction engine 102 may receive and/or transmit data via communications network 104 (e.g., the Internet, and/or the like) with any number of other devices, such as with one or more of user devices 112 (associated with a user 110), with one or more of servers 108A-108N, and/or with one or more clustering engines 106A-106N. While FIG. 1 depicts clustering engines 106A-106N as being distinct devices relative to influence prediction engine 102, in some examples, the influence prediction engine 102 may include one or more of the clustering engine(s) 106A-106N. In many embodiments, the influence prediction engine 102 may cause execution of operations by one or more of the clustering engine(s) 106A-106N.

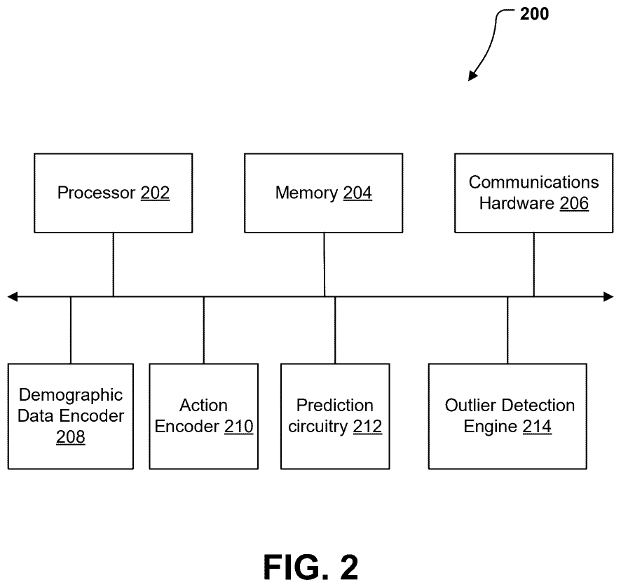

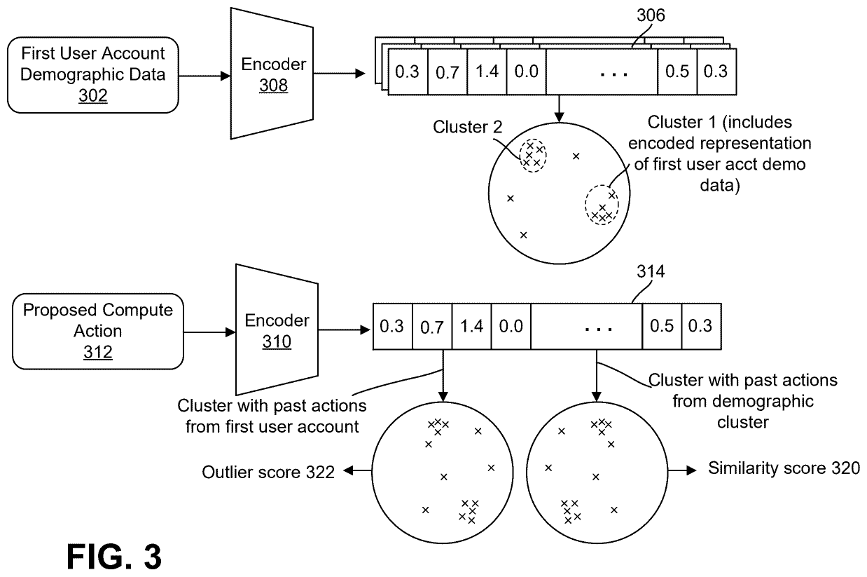

The influence prediction engine 102 may be implemented as one or more computing devices and/or servers, which may be composed of a series of components. Particular components of the influence prediction engine 102 are described in greater detail below with reference to apparatus 200 in connection with FIG. 2 and encoders 308 and 310 in connection with FIG. 3. In some examples, the influence prediction engine 102 (and/or any component associated with the influence prediction engine 102 as described below in connection with apparatus 200) may be integrated with (or using) one or more Integrated Development Environments (IDEs), Continuous Integration (CI) pipelines, and/or Continuous Development (CD) pipelines in order to facilitate use of the influence prediction engine 102 (e.g., without drastically altering an entities existing workflow). Use of the term “engine” with respect to elements of the apparatus 200 shall be interpreted as including the particular hardware configured to perform the functions associated with the particular element being described. Of course, while the term “engine” should be understood broadly to include hardware, in some examples, the term “engine” may refer to a combination of hardware components with software instructions that configure the hardware components to perform the various functions described herein.

In some embodiments, the influence prediction engine 102 may include a storage device (e.g., memory 204 of FIG. 2) that comprises a distinct component from other components of the influence prediction engine 102. Such a storage device may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). The storage device may host the software executed to operate the influence prediction engine 102. The storage device may store information relied upon during operation of the influence prediction engine 102, such as various encoded representations of proposed compute actions, past compute actions, demographic data, etc., that may be generated and/or used by the influence prediction engine 102, data and documents (e.g., corporate policies, sensitive data handling protocols, and/or the like) to be analyzed using the influence prediction engine 102, and/or the like. In addition, the storage device may store control signals, device characteristics (e.g., Operating System (OS), Internet Protocol (IP) Address, and/or the like), and/or access credentials (e.g., security certificates, passwords, handshake protocols, and/or the like) enabling interaction between the influence prediction engine 102 and one or more of the one or more of user devices 112, with server(s) 108A-108N, and/or with one or more clustering engines 106A-106N.

The one or more user devices 112, server(s) 108A-108N, and the one or more clustering engines 106A-106N may be embodied by any computing devices known in the art. The one or more user devices 112, server(s) 108A-108N, and the one or more clustering engines 106A-106N need not themselves be independent devices but may be peripheral devices communicatively coupled to other computing devices and/or may be components of the influence prediction engine 102 or other devices. In some examples, the clustering engines 106A-106N may be embodied as software that may be executed by the influence prediction engine 102 and/or one or more other devices.

Although FIG. 1 illustrates an environment and implementation in which the influence prediction engine 102 and/or server(s) 108A-108N interact with a user device 112 indirectly, in some embodiments users may directly interact with the influence prediction engine 102 (e.g., via a user interface and/or communications hardware of the influence prediction engine 102) and/or the influence prediction engine 102 may comprise one or more clustering engines 106A-106N and/or the server(s) 108A-108N, in which case one or more separate clustering engines 106A-106N and/or server(s) 108A-108N may not be utilized.

### Example Implementing Apparatuses

The influence prediction engine 102 (described previously with reference to FIG. 1) may be embodied by one or more computing devices or servers, shown as apparatus 200 in FIG. 2. The apparatus 200 may be configured to execute various operations described above in connection with FIG. 1 and/or below in connection with FIGS. 3-6. As illustrated in FIG. 2, the apparatus 200 may include processor 202, memory 204, communications hardware 206, demographic data encoder 208 (e.g., demographic data encoder circuitry), action encoder 210 (e.g., action encoder circuitry), prediction circuitry 212 (e.g., FCN circuitry), and/or outlier detection engine 214 (e.g., circuitry effective to calculate similarity and/or detect outliers), each of which will be described in greater detail below.

The processor 202 (and/or co-processor or any other processor assisting or otherwise associated with the processor) may be in communication with the memory 204 via an interconnect for passing information amongst components of the apparatus. The processor 202 may be embodied in a number of different ways and may, for example, include one or more processing devices configured to perform independently. Furthermore, the processor may include one or more processors configured in tandem via an interconnect to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processor 202 for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include one or more of a keyboard, mouse, touch screen, touch area, soft key, microphones, speaker, light (e.g., light emitting diode (LED), etc.), and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises demographic data encoder 208 that may be any means such as a device or circuitry embodied in either hardware or a combination of hardware and software that is configured to receive demographic data (e.g., from any number of servers 108A-108N and/or user devices 112 user via communications hardware 206 and/or the like) and encode such demographic data into numeric representations thereof (such as vectors representing the attributes of the demographic information). The demographic data encoder 208 may utilize processor 202, memory 204, or any other hardware component included in the apparatus 200 to perform these operations which are described in greater detail below in connection with FIGS. 3-6. For example, parameters (e.g., learned parameters of a machine learning encoder) may be stored in memory 204 and loaded into registers and/or buffers of processor 204 for execution. The processor 202 may perform various actions using instructions and/or parameters stored in memory 204 to implement the demographic data encoder 208. For example, if the demographic data encoder 208 comprises a fully-connected network, the processor 204 may perform matrix multiplication and addition to compute values at each layer of the fully-connected network.

For example, in FIG. 3, the encoder 308 may be an example of a demographic data encoder 208. As depicted in FIG. 3, the encoder 308 may receive demographic data from a plurality of user accounts (e.g., accounts registered with server(s) 108A-108N). Such demographic data may include first user account demographic data 302 which may be data describing different attributes of a first user account (e.g., account status, age, sex, place of residence, affiliations/groups, employment, etc.). The specific examples of user account demographic data encoded by encoder 308 may vary according to the desired implementation and the available demographic data associated with the accounts. The encoder 308 may encode the first user account demographic data 302 to generate the encoded representation 306 of the first user account demographic data 302 (e.g., a multidimensional vector). Similarly, the encoder 308 may encode demographic data associated with other user accounts to generate a plurality of vector representations, where each vector representation represents the demographic data of a different user account. The vector representations may be of the same form (e.g., the vector representations may have the same number of elements with each element corresponding to the same account attribute) with the values of each element varying according to the specific demographic attributes of the relevant account.

Demographic data may be updated and re-encoded over time as attributes associated with different accounts may change. In various examples, the demographic data may be clustered using one or more of the clustering engines 106A-106N of FIG. 1 which may either be included in the influence prediction engine 102 or which may be configured in communication with the influence prediction engine 102. As shown in FIG. 3, clustering of the vector representations may result in groups of similar vectors (e.g., representing clusters of peer accounts) being clustered together on the basis of similar demographic data representations. For example, Cluster 1 in FIG. 3 may include encoded representations (e.g., vectors) of various accounts including an encoded representation 306 of the first user account demographic data 302. The various encoded representations in Cluster 1 may be similar to one another (e.g., within a threshold cosine distance and/or having greater than or equal to a threshold cosine similarity) and may be more similar to one another (as evaluated using the desired similarity/distance metric) than such encoded representations are to the data points of any other cluster (including Cluster 2). Accordingly, such encoding and clustering techniques may be used to determine a peer-group for a given user account (e.g., the first user account) on the basis of similarity in demographic data. A peer group for a user account may be a subset of the total number of user accounts (e.g., the subset of accounts that are more similar to one another (in the relevant vector space) than such accounts are to accounts of a different cluster). In the example of FIG. 3, the other vector representations included in Cluster 1 with the encoded representation 306 may each be associated with an account that is deemed to be a peer of the first user account (by virtue of such accounts being in the same cluster as the first user account).

Returning to FIG. 2, the apparatus 200 further comprises action encoder 210 that may be any means such as a device or circuitry embodied in either hardware or a combination of hardware with software, and that is configured to receive action data (e.g., proposed compute action data and/or past compute action data (indicating past executed compute actions) from any number of servers 108A-108N and/or user devices 112 user via communications hardware 206 and/or the like) and encode such compute action data into numeric representations thereof (such as vectors representing the compute action data). The action encoder 210 may utilize processor 202, memory 204, or any other hardware component included in the apparatus 200 to perform these operations which are described in greater detail below in connection with FIGS. 3-6. For example, parameters (e.g., learned parameters of a machine learning encoder) may be stored in memory 204 and loaded into registers and/or buffers of processor 204 for execution. The processor 202 may perform various actions using instructions and/or parameters stored in memory 204 to implement the action encoder 210. For example, if the action encoder 210 comprises a fully connected network, the processor 204 may perform matrix multiplication and addition to compute values at each layer of the fully connected network.

For example, in FIG. 3, the encoder 310 may be an example of the action encoder 210. As depicted in FIG. 3, the encoder 310 may receive proposed compute action 312 (e.g., representing a compute action proposed by user device 112 that is received from user device 112 and/or server(s) 108A-108N (in the case where the server(s) 108A-108N are the device on which the proposed compute action 312 is to be executed)). The encoder 310 may generate encoded representation 314 which may encode different attributes of the proposed action to be taken. For example, if the proposed action is a registration request for an account, the encoded representation 314 may be a vector with elements representing such attributes as an account identifier (representing the account to be registered), an account status, the service to which to register the account, etc. In a different example, the proposed compute action 312 may be a stock purchase. In such an example, the encoded representation 314 may represent different elements such as a target price to pay per share, a number of shares to purchase, a date on which the shares should be purchased, etc. As can be seen from the foregoing examples, the particular encoded representations of compute actions may vary according to the type of compute action being encoded by encoder 310. Past compute actions associated with both the relevant user account and with the accounts of other registered users may be similarly encoded.

In some examples, the encoded representation 314 of the proposed compute action 312 may be clustered (e.g., using one or more of clustering engines 106A-106N) with encoded representations of past actions associated with the same user account. Such clustering may be used to determine if the current proposed compute action 312 is an outlier with respect to past actions taken by the same user account. For example, if the Z-score (an example of outlier score 322) for the encoded representation 314 is greater than a threshold Z-score this may indicate that the proposed compute action 312 is anomalous with respect to past compute actions associated with the user account. In another example, the current proposed compute action 312 may be determined to be an outlier if the encoded representation 314 is not included in any clusters of past compute actions for the first user account. In various examples, the outlier detection engine 214 of apparatus 200 may be used to calculate the similarity score of the proposed compute action 312 with respect to past compute actions of the user account. As described in further detail below, the similarity score may be used, at least in part, to determine a predicted influence for the proposed compute action 312. The outlier detection engine 214 may be implemented by any means such as a device or circuitry embodied in either hardware or a combination of hardware and software.

In some examples, the encoded representation 314 of the proposed compute action 312 may be clustered (e.g., using one or more of clustering engines 106A-106N) with encoded representations of past actions associated with peers of the user account (e.g., the subset of other accounts that have been clustered together with the user account on the basis of similar demographic data (e.g., the accounts represented by the encoded representations in Cluster 1 in FIG. 3)). In various examples, clustering of the encoded representation 314 of the proposed compute action 312 with the encoded representations of past actions of the peers of the user account may be conditioned on the outlier score 322 of the proposed action with respect to past actions of the user's account being below a threshold similarity. In other words, determining a similarity score 320 between the proposed compute action 312 and past actions of the user account's peer-group (e.g., the accounts in Cluster 1) may be conditioned on the proposed compute action 312 being an outlier with respect to past actions associated with the user account. This conditional logic may be employed based on the intuition that proposed compute actions which are similar to compute actions that the user has taken in the past may not be strongly predictive of peer-based influence.

The encoded representation 314 of the proposed compute action 312 may be clustered (e.g., using one or more of clustering engines 106A-106N) with encoded representations of past actions associated with peers of the user account to generate similarity score 320. Similarity score 320 may represent a similarity between the encoded representation 314 of the proposed compute action 312 and past compute actions performed by the peers of the user account (e.g., the other accounts associated with Cluster 1). The similarity score 320 may be, for example, a cosine similarity, a cosine distance, a Jaccard similarity, etc. By contrast, the outlier score 322 may represent the distance between the encoded representation 314 of the proposed compute action 312 and past compute actions performed by the first user account.

A proposed compute action 312 having a relatively high outlier score 322 and a relatively high similarity score 320 may be indicative of peer-based influence. In various examples, rule-based logic (e.g., a heuristic) may be used to combine the outlier score 322 and the similarity score 320 to generate an influence prediction score. For example, a weighted combination of the similarity score 320 and the outlier score 322 may be used as the influence prediction score (where the weights may be individually tuned according to the desired implementation). In some other examples, the apparatus 200 may include prediction circuitry 212 that may implement a supervised machine learning model (e.g., a Fully Connected Network (FCN)) that may take the outlier score 322 and the similarity score 320 as input and may output a predicted influence prediction score.

Returning to FIG. 2, the apparatus 200 further comprises prediction circuitry 212, which may be any means such as a device or circuitry embodied in either hardware or a combination of hardware and software that is configured to implement a machine learning model such as an FCN or other type of neural network for combining the outlier score 322 and the similarity score 320 to generate an influence prediction score. In various examples, the prediction circuitry 212 may be implemented using an ASIC and/or programmable circuit (e.g., a field programmable gate array) that may perform vector and/or matrix multiplication. Additionally, the prediction circuitry 212 may include one or more accumulator circuits and/or buffers to store accumulated values (e.g., values for intermediate hidden layers of an FCN). In various other examples, the processor 202 may perform matrix and/or vector multiplication and/or addition and pass the generated values to the prediction circuitry 212. In some instances, the memory 204 may store intermediate and/or output values generated during computation by the prediction circuitry 212. In still further examples, the memory 204 may store training data and/or learned parameters for a supervised machine learning model implemented using the prediction circuitry 212. In various examples, the prediction circuitry 212 may implement a neural network or other supervised machine learning model that may be trained using training data samples including a similarity score, outlier prediction score pair. The pair may be labeled with an influence prediction score. The similarity score indicates a similarity of a given compute action to past actions of the user account's peer group, while the outlier score indicates a degree to which the proposed action is an outlier with respect to past actions of the user account. The outlier score 322 and similarity score 320 may be generated by the outlier detection engine 214, as described above. Generally, the combination of a high outlier score (e.g., outlier score 322) and a high similarity score (e.g., similarity score 320) may be associated with high peer-based influence, while the combination of a low outlier score and a low similarity score may be associated with low peer-based influence.

During training, a supervised machine learning model implemented by the prediction circuitry 212 may generate a predicted influence score for a given similarity score, outlier score pair. The predicted influence may be compared to the influence prediction score label and the loss may be determined. A gradient may be calculated using the loss across all training samples in a given training iteration (according to the desired loss function (e.g., cross entropy loss)). Back propagation may be used to modify parameters of the supervised machine learning model implemented using prediction circuitry 212 using the calculated gradient to minimize the loss. The training may continue until the supervised machine learning model converges. Thereafter, for a given proposed compute action (e.g., the proposed compute action 312), the outlier score 322 and similarity score 320 may be generated (as described above) and input into the prediction circuitry 212. The prediction circuitry 212 may predict an influence prediction score for the proposed compute action 312. In various examples, the influence prediction score may be displayed on a user device associated with the proposed compute action 312. In some instances, the proposed compute action 312 may be programmatically prevented from being executed until an acknowledgement of the influence prediction score is received. In some other examples, the influence prediction score may be sent to other devices for tracking and/or storage so that influence trends for the user account may be determined. In yet another example, the influence prediction score may be used as a guardrail to programmatically prevent certain actions if the predicted influence is too high. For example, a parent may have parental controls for controlling certain permissions on a child's account. The parent may configure the child's account so that certain compute actions are programmatically disabled when the influence prediction associated with such compute actions is above a certain threshold. Additionally, in some examples, the parent account may be alerted when actions are predicted to be highly influenced by the user's peer group (as determined using the influence prediction scores described above). The specific actions taken using the influence prediction score may vary according to the desired implementation.

The apparatus 200 further comprises outlier detection engine 214, which may be any means such as a device or circuitry embodied in either hardware or a combination of hardware and software that is configured to calculate an outlier score (e.g., outlier score 322). For example, the outlier detection engine 214 may be implemented as an ASIC and/or programmable circuit that calculates Z-scores for input encoded representations of proposed compute actions of the same account to determine if the proposed compute action represents a statistical outlier with respect to the past actions of the account. For example, the outlier detection engine 214 may include a first circuit that may calculate a standard deviation of a distribution of encoded representations of compute actions. The outlier detection engine 214 may include a second circuit that may determine a difference between an observed encoded representation of a compute action (e.g., encoded representation 314) and a mean encoded representation for the distribution of encoded representations. The outlier detection engine 214 may include a multiplier circuit that may be effective to divide (e.g., multiply by the inverse) the difference between the observed value and the mean value by the standard deviation to compute a Z-score. In some examples, one or more of these example operations may instead be performed by processor 202 and/or another component. In various examples, the outlier detection engine 214 may include a comparator circuit that may compare the calculated Z-score to a threshold Z-score stored in memory (e.g., memory 204 and/or a memory of the outlier detection engine 214). In another example, the current proposed compute action (e.g., proposed compute action 312) may be determined to be an outlier if the encoded representation is not included in any clusters of past compute actions for the first user account. As described in further detail below, the similarity score may be used, at least in part, to determine a predicted influence for the proposed compute action.

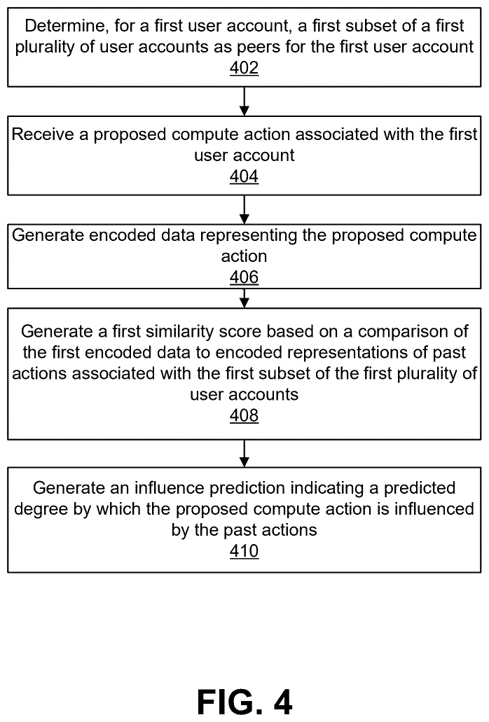

The various components of apparatus 200 in FIG. 2 may be implemented in hardware, software (e.g., execution of computer-executable instructions using processor 202), and/or some combination thereof. In examples where demographic data encoder 208, action encoder 210, prediction circuitry 212, and/or outlier detection engine 214 are implemented in hardware, application specific integrated circuits (ASICs) and/or field programmable gate arrays (FPGAs) may be used to implement such components. For example, a combination of adder circuits, accumulator circuits, and multiplier circuits may be used to implement demographic data encoder 208, action encoder 210, prediction circuitry 212, and/or outlier detection engine 214. Operation of these components are described in further detail below in reference to FIGS. 4-6.

Although components 202-214 are described in part using functional language, it will be understood that the particular implementations necessarily include the use of particular hardware. It should also be understood that certain of these components 202-214 may include similar or common hardware. For example, the demographic data encoder 208, action encoder 210, prediction circuitry 212, and/or outlier detection engine 214 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 200 to perform the various functions described herein.

Although the demographic data encoder 208, action encoder 210, prediction circuitry 212, and/or outlier detection engine 214 may leverage the processor 202, memory 204, or communications hardware 206 as described above, it will be understood that any of the demographic data encoder 208, action encoder 210, prediction circuitry 212, and/or outlier detection engine 214 may include one or more dedicated processors, specially configured field programmable gate array (FPGA), or application specific interface circuit (ASIC) to perform its corresponding functions, and may accordingly leverage the processor 202 for executing software stored in a memory (e.g., memory 204), or communications hardware 206 for enabling any functions not performed by special-purpose hardware. In all embodiments, however, it will be understood that the demographic data encoder 208, action encoder 210, prediction circuitry 212, and/or outlier detection engine 214 comprise particular machinery designed for performing the functions described herein in connection with such elements of apparatus 200.

Having described specific components of example apparatuses (e.g., apparatus 200), example embodiments are described below in connection with a series of flowcharts.

### Example Operations

Turning to FIGS. 4, 5, and 6, example flowcharts are illustrated that contain example operations implemented by example embodiments described herein. The operations illustrated in FIGS. 4, 5, and 6 may, for example, be performed by a system device (e.g., server, etc.) of the influence prediction engine 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, demographic data encoder 208, action encoder 210, prediction circuitry 212, and/or outlier detection engine 214, and/or any combination thereof. Additionally, in some examples, one or more of the clustering engines 106A-106N may be implemented by influence prediction engine 102 (e.g., apparatus 200) and may be used to perform one or more of the operations described in reference to FIGS. 4, 5, and 6, and may be hosted by influence prediction engine 102 or may be hosted as separate components operating under the direction of the influence prediction engine 102.

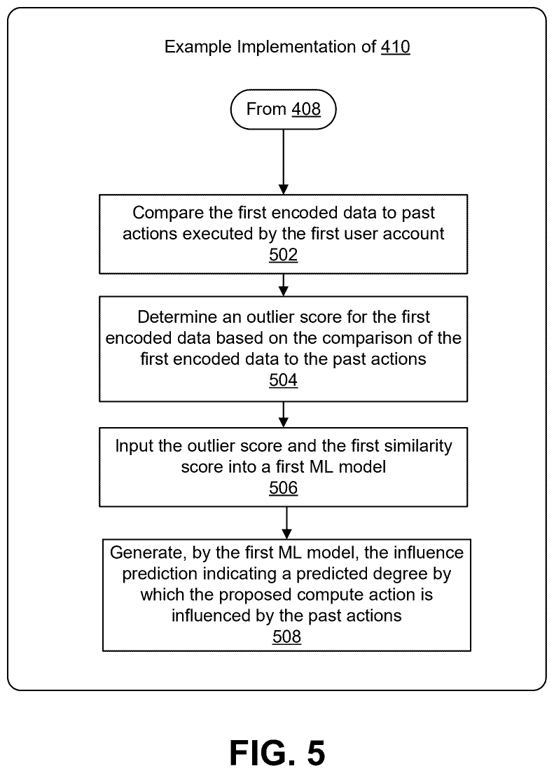

It will be understood that user interaction with the influence prediction engine 102 may occur directly via communications hardware 206, or may instead be facilitated by a separate user device (e.g., any of user devices 112 shown in FIG. 1), and which may have similar or equivalent physical componentry facilitating such user interaction. It will be understood that clustering engine 106A-106N interaction and/or server(s) 108A-108N interaction with the influence prediction engine 102 may occur directly via communications hardware 206, or may instead be facilitated by a separate user device. In various examples, one or more operations described in reference to FIGS. 4, 5, and/or 6 may be implemented using instructions selected from a native instruction set architecture of the relevant hardware (e.g., the hardware discussed above in reference to apparatus 200).

Turning to FIG. 4, example operations are shown for peer-based influence prediction for compute actions (and/or proposed compute actions).

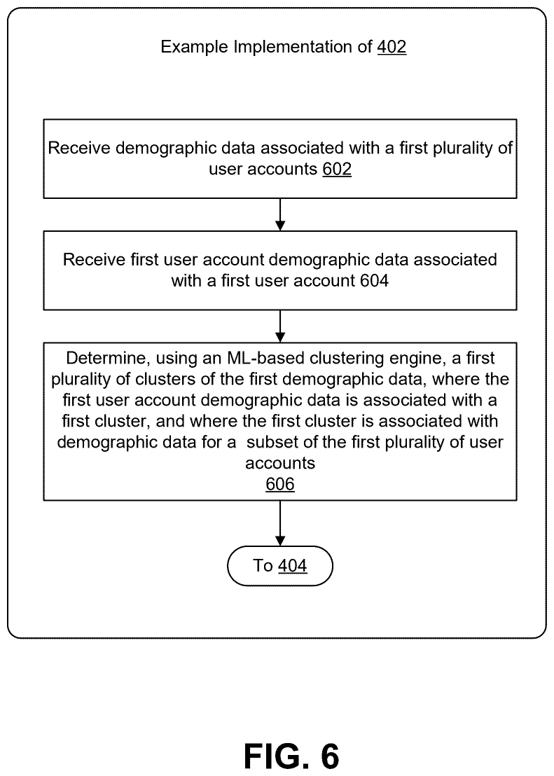

As shown by operation 402, the apparatus 200 may include means, such as processor 202, memory 204, communications hardware 206, clustering engines 106A-106N, or the like, for determining, for a first user account, a first subset of a first plurality of user accounts as peers for the first user account. The first plurality of user accounts may be a set of accounts being considered in a determination of peer accounts for the first user account. The first subset of the first plurality of user accounts may be the accounts determined to be peers for the first user account. The peer account determination may be made using the various techniques described herein. For example, the processor 202 may call an API of one or more clustering engines 106A-106N using the communications hardware 206. The processor 202 may receive the first subset of the first plurality of user accounts (e.g., the peer accounts) from one or more of the clustering engines 106A-106N via communications hardware 206 and may store data representing the first subset in memory 204. Further examples of operation 402 are described in further detail below in reference to FIG. 6.

As shown by operation 404, the apparatus 200 may include means, such as processor 202, memory 204, and/or communications hardware 206, for receiving, via communications hardware 206, a proposed compute action associated with the first user account. For example, the first user account may request execution of a proposed compute action associated with the influence prediction engine 102 and/or a service associated with the influence prediction engine 102 (e.g., a service provided by one or more server(s) 108A-108N that are configured in communication with the influence prediction engine 102 via communications network 104). In various examples, data representing the proposed compute action may be retrieved from memory 204 by a read command issued by processor 202. The specific proposed compute action may vary according to the services offered for the first user account. Examples may include an online purchase, initiation of a download, installation of an application, purchase of an investment, a request to exfiltrate data from a particular secured server, etc.

As shown by operation 406, the apparatus 200 may include means, such as action encoder 210 or the like, for generating encoded data representing the proposed compute action. For example, the proposed compute action may have a variety of attributes (e.g., data and/or metadata) associated with it. Such attributes may be encoded by action encoder 210 to generate an encoded representation of the proposed compute action (e.g., encoded representation 314 of FIG. 3). For example, if the proposed compute action is streaming a particular movie, the encoded representation may represent a runtime of the movie, a genre of the movie, one or more actors in the movie, a studio associated with the movie, semantic information about the movie, etc. The encoded data representing the movie may be, for example, a vector comprising various elements which represent different attributes of the proposed compute action. It should be noted that the specific representation of the encoded data may vary according to the type of proposed compute action being encoded, the attributes of the compute action being encoded, and according to the proposed encoding scheme.

As shown by operation 408, the apparatus 200 may include means, such as outlier detection engine 214 or the like, for generating a first similarity score based on a comparison of the first encoded data to encoded representations of past actions associated with the first subset of the first plurality of user accounts. For example, the outlier detection engine 214 may compare the first encoded data representing the proposed compute action to encoded representations of past actions of the peer group determined for the first user account. In such an example, the first subset of the first plurality of user accounts are the peers of the first user account as described in operation 402 and as further described in reference to FIG. 6. In some examples, the outlier detection engine 214 may compare the first encoded data with each past action (or some selected sample of past actions) associated with the first subset of the first plurality of user accounts. For example, the outlier detection engine 214 may calculate cosine similarity, Jaccard similarity, Euclidean distance, etc., to determine a similarity (or distance) between the first encoded data and respective ones of the encoded representations of past actions. In some examples, the outlier detection engine 214 may combine the similarity scores (e.g., by averaging the similarity scores, adding the similarity scores, etc.) to determine an overall similarity score representing a similarity between the proposed compute actions and past actions of the peers of the first user account. In some examples, the first similarity score of operation 408 may be such a combined similarity score. In various examples, the encoded representations of the past actions of the peers may be time-annealed (e.g., using a weighting factor multiplied by the similarity scores) by the outlier detection engine 214 such that more recent actions are given greater weight when comparing the similarity between the proposed compute action and a past action of a peer account. In some examples, the outlier detection engine 214 may weight past actions that occurred more than a threshold amount of time in the past with a weight of 0, such that these actions are not considered when generating the first similarity score. The intuition may be that actions in the distant past may be unlikely to have influenced a user's recent actions. In some other examples, the outlier detection engine 214 may only compare past compute actions from within a threshold period of time to the proposed compute action (e.g., for computational efficiency, latency reduction, and/or to only consider more recent compute actions for purposes of influence prediction).

As shown by operation 410, the apparatus 200 may include means, such as prediction circuitry 212 for generating an influence prediction indicating a predicted degree by which the proposed compute action is influenced by the past actions. In various examples, the prediction circuitry 212 may generate the influence prediction using the first similarity score of operation 408. Examples of operation 410 are described in further detail below in reference to FIG. 5.

In some examples, operation 410 may be performed in accordance with the operations described by FIG. 5. Turning to FIG. 5, example operations are shown for generating an influence prediction indicating a predicted degree by which a proposed compute action is influenced by past actions from peer accounts of the first user account.

As shown by operation 502, the apparatus 200 may include means, such as action encoder 210 and/or clustering engines 106A-106N for comparing the first encoded data to past actions executed by the first user account. For example, the action encoder 210 may encode a first set of past actions associated with the first user account. In various examples, a machine learning-based clustering engine (e.g., one or more of clustering engines 106A-106N) may be used to generate a plurality of clusters of the first set of past actions. In at least some examples, the first encoded data may be an input to the machine learning-based clustering engine such that the first encoded data may be clustered with the first set of past actions.

As shown by operation 504, the apparatus 200 may include means, such as outlier detection engine 214 for determining an outlier score for the first encoded data based on the comparisons of the first encoded data to the past actions. The outlier detection engine 214 may determine whether the first encoded data is included in any clusters among the clusters generated by the machine learning-based clustering engines. If the first encoded data is not included in any cluster among the clusters generated by the machine learning-based clustering engines, the outlier detection engine 214 may generate data designating the first encoded data as an outlier. An outlier score may be, for example, a Z-score for the first encoded data (e.g., a distance between the first encoded data and a cluster centroid, divided by the standard deviation).

As shown by operation 506, the apparatus 200 may include means, such as processor 202, memory 204, and/or prediction circuitry 212 for inputting the outlier score and the first similarity score into a first machine learning model. For example, processor 202 may retrieve the outlier score and the first similarity score from memory 204. Processor 202 may input the similarity score generated at operation 408 and the outlier score determined at operation 504 into prediction circuitry 212 (which may implement a supervised machine learning model, as described above in reference to FIG. 2).

As shown by operation 508, the apparatus 200 may include means, such as prediction circuitry 212 for generating, by the first machine learning model, the influence prediction indicating a predicted degree by which the proposed compute action is influenced by the past actions. For example, a supervised machine learning model may be implemented by the prediction circuitry 212. The supervised machine learning model may be trained to generate an influence prediction score for an input similarity score and outlier score, where the similarity score represents the similarity between the proposed compute action and past action of the first user account's peer group and the outlier score represents a dissimilarity between the proposed compute action and past actions associated with the first user account. Generally, high similarity scores and high outlier scores may result in a higher degree of peer-based influence, while lower similarity scores and lower outlier scores may result in a lower degree of peer-based influence for the proposed compute action.

The influence prediction score may be used to take various downstream actions, which may vary according to the desired implementation. For example, execution of the proposed compute action may be conditioned on the influence prediction score being below a threshold. In another example, the influence prediction score may trigger a notification to one or more other devices and/or accounts (e.g., a secondary device associated with the first user account, such as a device operated by a financial advisor and/or analyst associated with the user account). It should be noted that the specific downstream actions are implementation details that can vary according to the desired implementation.

In some examples, operation 402 may be performed in accordance with the operations described by FIG. 6. Turning to FIG. 6, example operations are shown for determining, for the first user account, a first subset of a first plurality of user accounts as peers for the first user account.

As shown by operation 602, the apparatus 200 may include means, such as memory 204, communications hardware 206, and/or demographic data encoder 208 for receiving demographic data associated with a first plurality of user accounts. For example, the demographic data encoder 208 may access demographic data associated with a plurality of user accounts. In some examples, the demographic data may be received via communications hardware 206 and/or retrieved from memory 204. The specific demographic data may depend on the desired implementation, the nature of the accounts, the specific service being offered, etc. By way of example, the demographic data may include age, sex, geographic location information, account status information, social media contact information, place of residence, etc. The demographic data encoder 208 may generate encoded representations of the demographic data for each of the plurality of user accounts. The plurality of user accounts may be associated with a service from which the proposed compute action is requested by the first user account and/or may be user accounts from a different service (e.g., from a social media network).

As shown by operation 604, the apparatus 200 may include means, such as memory 204, communications hardware 206, and/or demographic data encoder 208, for receiving first user account demographic data associated with the first user account. The user account demographic data may be received via communications hardware 206 (e.g., from another device) and/or may be retrieved from memory 204. For example, the demographic data encoder 208 may encode the demographic data for the first user account.

As shown by operation 606, the apparatus 200 may include means, such as clustering engines 106A-106N for determining, using an machine learning-based clustering engine, a first plurality of clusters of the first demographic data, where the first user account demographic data is associated with a first cluster, and where the first cluster is associated with demographic data for a subset of the first plurality of user accounts. For example, one or more of clustering engines 106A-106N may use a distance metric (e.g., cosine distance) to determine a distance between each data point (e.g., the encoded demographic data for each subject account including the first user account). Clustering engines 106A-106N may cluster data points which are more similar to one another (e.g., have closer cosine distances) than they are to any other data point together in the same cluster. Clustering engines 106A-106N may generate data that designates data points in the same cluster as the encoded demographic data for the first user account as peers for the first user account. Thereafter, as described in reference to FIG. 4, these peer accounts may be used to determine a predicted level of influence on the proposed compute action. For example, the outlier detection engine 214 may determine similarities between an encoded representation of the proposed compute action and encoded representations of past compute actions of the peer group (e.g., the accounts in the same cluster as the first user account). Outlier detection engine 214 may combine these similarities determine the first similarity score (e.g., from operation 408).

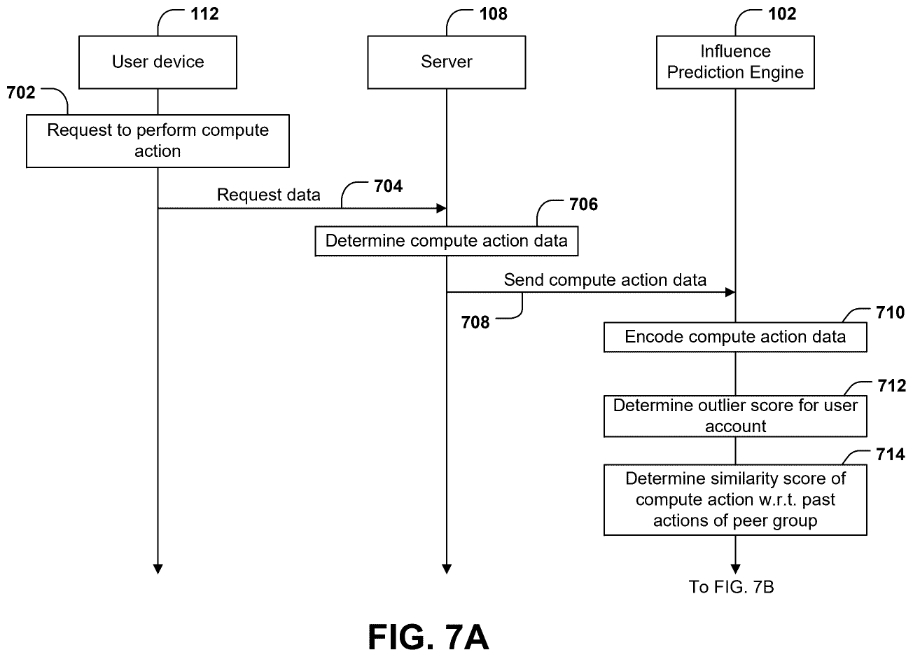

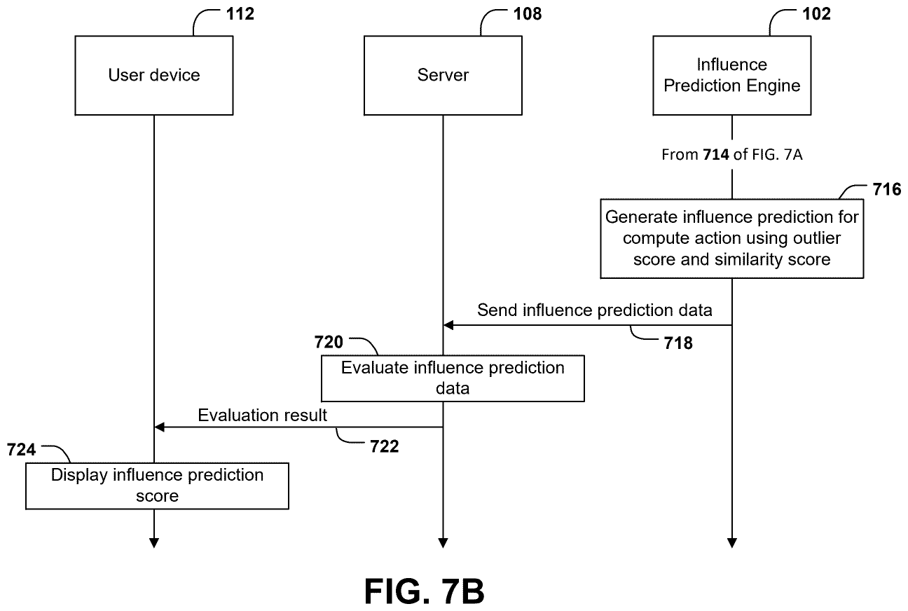

FIGS. 7A-7B illustrate an example swim-lane diagram illustrating example operations for peer-based influence prediction in accordance with various examples described herein. The various operations described in reference to FIGS. 7A-7B may be performed by apparatuses, methods, and/or computer program products described herein. For example, the various operations described in reference to FIGS. 7A-7B may be performed by hardware, firmware, circuitry, and/or devices associated with execution of software including one or more computer-executable instructions.

User device 112 may be a device on which a user may request execution of a compute action (e.g., a proposed compute action) (block 702). In various examples, the proposed compute action may be associated with a given user account. For example, a frontend application may be executed on the user device 112 and the user may be logged into an account associated with the frontend application. Server 108A-108N may represent a corresponding backend for the frontend application executing on the user device 112.

Request data 704 may be sent to the server 108A-108N to request execution of the compute action (e.g., downloading content, purchasing an item, updating account information, etc.). At block 706, the server 108A-108N may determine the appropriate compute action data associated with the request data 704. For example, if the proposed compute action is a request to purchase stock, the compute action data may represent various parameters associated with the request, such as the type of stock to purchase, the number of shares, the trade execution day/time, the price at which to purchase the shares, etc. If the proposed compute action is a request to download content the compute action data may represent a port on which the download is to be initiated, a file path representing a storage location of the downloaded content, a user account ID identifying the user account and/or user account permissions, etc.

The server 108A-108N may send the compute action data 708 representing various attributes of the proposed compute action to the influence prediction engine 102. At block 710, the influence prediction engine 102 may encode the compute action data to generate an encoded representation of the compute action data 708 (block 710). For example, the action encoder 210 of apparatus 200 may be used to generate the encoded representation of the compute action data 708.

At block 712, the influence prediction engine 102 may determine whether the proposed compute action is a statistical outlier with respect to past actions associated with the user account. For example, the influence prediction engine 102 may cluster the encoded compute action data with encoded representations of past actions taken by the user account to determine whether the encoded compute action data represents a statistical outlier with respect to the past actions. For example, the encoded compute action data may be an outlier if the encoded compute action data is not included in any cluster of past compute actions for the user account. In other examples, if a Z-score for the encoded compute action data exceeds a threshold the encoded compute action data may be designated as an outlier. The particular outlier detection technique may vary according to the desired implementation. An outlier score may represent the degree to which the encoded compute action is dissimilar from other past actions taken in association with the user account.

Although not shown in FIG. 7A, the influence prediction engine 102 may have previously determined a peer group for the user account requesting the compute action. For example, the influence prediction engine 102 may encode demographic data associated with the user account and may cluster the encoded demographic data with demographic data representing other accounts to determine a subset of accounts as peers for the user account (as previously described).

At block 714, the influence prediction engine 102 may determine a similarity score of the compute action with respect to past actions taken by a peer group for the user account. For example, the influence prediction engine 102 may cluster the encoded compute action data 708 with encoded representations of past actions taken by the accounts in the user account's peer group. A similarity metric (or distance metric) may be used to generate a similarity score indicating a similarity (or distance) in the relevant vector space between the encoded representation of the compute action and each of the past compute actions associated with the user account's peer group. In at least some examples, processing may proceed from block 712 to block 714 on the condition that the outlier score indicates that the proposed compute action is sufficiently different from past actions associated with the user account. For example, if the outlier score (indicating dissimilarity with respect to past actions of the user account) is above a particular outlier score threshold, processing may continue from block 712 to block 714. Conversely, if the outlier score is below the threshold, processing may be terminated and/or a predefined low influence prediction may be returned.

In cases where processing at block 714 is performed, processing may continue at block 716 of FIG. 7B after performing the operation of block 714. At block 716, an influence prediction score may be generated for the compute action using the outlier score and the similarity score. For example, in some embodiments, the outlier score and the similarity score may be input into a machine learning model (e.g., implemented using prediction circuitry 212) and the supervised machine learning model implemented using prediction circuitry 212 may be trained to output an influence prediction for the input outlier score/similarity score pair. In some further examples, the outlier score and similarity score may be combined (e.g., using a heuristic) to generate the influence prediction. For example, a weighted combination of the outlier score and the similarity score may be used as the influence prediction.

Influence prediction data 718 representing the influence prediction output by the influence prediction engine 102 may be sent to the server 108A-108N. At block 720, the server 108A-108N may evaluate the influence prediction data. For example, the server 108A-108N may execute logic to determine whether to take the proposed compute action based on the influence prediction data. In at least some examples, the server 108A-108N may programmatically prevent the proposed compute action from being executed based on a relatively high influence prediction score (e.g., an influence prediction score above a tuneable threshold value). In some examples, if the influence prediction score is above some threshold level, the server 108A-108N may programmatically require that the user acknowledge a message indicating the predicted influence prior to execution of the action. The particular logic implemented by the server 108A-108N in response to the generated influence prediction may vary according to the desired implementation.

The evaluation result 722 generated by the server 108A-108N after evaluation of the influence prediction data may be sent to the user device. For example, as shown by block 724, receipt of the evaluation result 722 may cause the user device 112 to display an influence prediction score and/or graphic. In some embodiments, the user device may require an acknowledgement of the influence prediction score prior to execution of the proposed compute action.

### CONCLUSION

As described above, example embodiments provide methods and apparatuses that enable prediction of peer-based influence for proposed compute actions. Example embodiments thus provide tools that overcome the problems faced by conventional subjective, and/or manual, systems for predicting influence of compute actions in an online setting. Using quantitative techniques to generate predictions of peer-based influence on proposed compute actions enables computer-executable logic to be deployed that can condition execution of the proposed compute action on the degree of predicted influence. In some other examples, the proposed compute action may be modified based on the influence prediction score. Additionally, the predicted peer-based influence may be used to alert a user, who may otherwise be subjectively unaware of any influence for a proposed compute action. Further, trends in peer-based influence prediction may be monitored by a system and/or entity to determine account-specific susceptibility to trends and/or peer-based influence. Different content may be provided to different users on the basis of past peer-based influence predictions associated with the different user accounts. Furthermore, since influence may be subconscious, there may not be a way to adequately predict, model, and/or quantify influence based on user perceivable and/or reported signals. Accordingly, the specific techniques described herein may enable computing devices to objectively model influence prediction for peer-groups even when such influence may be otherwise undetectable using observable signals.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for generating compute action influence predictions, the method comprising:
determining, by at least one clustering engine for a first user account, a first subset of a first plurality of user accounts as peers for the first user account;
receiving, by communications hardware, a proposed compute action associated with the first user account;
generating, by an action encoder, first encoded data representing the proposed compute action;
generating, by an outlier detection engine, a first similarity score based at least in part on the first encoded data and one or more encoded representations of past actions associated with the first subset of the first plurality of user accounts; and
generating, by prediction circuitry based at least in part on the first similarity score, an influence prediction for the proposed compute action, the influence prediction indicating a predicted degree by which the proposed compute action is influenced by the past actions.

2. The method of claim 1, further comprising:
receiving, by a demographic data encoder, first demographic data associated with the first plurality of user accounts;
receiving, by the demographic data encoder, first user account demographic data associated with the first user account; and
determining, using the at least one clustering engine, a first plurality of clusters of the first demographic data, wherein the first user account demographic data is associated with a first cluster of the first plurality of clusters, wherein the first cluster is associated with demographic data for the first subset of the first plurality of user accounts,
wherein selection of the first subset of the first plurality of user accounts as peers for the first user account is based on determination of the first plurality of clusters of the first demographic data.

3. The method of claim 1, further comprising:
generating the one or more encoded representations of past actions associated with the first subset of the first plurality of user accounts by the action encoder.

4. The method of claim 1, further comprising:
determining, by the action encoder, a first set of past actions associated with the first user account;
determining, using the at least one clustering engine, a plurality of clusters of the first set of past actions; and
determining, using the outlier detection engine, that the proposed compute action is a statistical outlier with respect to the plurality of clusters.

5. The method of claim 4, further comprising:
generating, by the outlier detection engine, the first similarity score based at least in part on the proposed compute action being the statistical outlier with respect to the plurality of clusters.

6. The method of claim 4, further comprising:
determining, using the outlier detection engine, an outlier prediction score; and
generating, by a fully connected network, the influence prediction using the first similarity score and the outlier prediction score.

7. The method of claim 6, further comprising:
receiving, by the prediction circuitry, training data comprising a second similarity score for a second proposed compute action, a second outlier prediction score for the second proposed compute action, and a prediction influence label;
generating, by the fully connected network, a second influence prediction using the second similarity score and the second outlier prediction score;
determining, by the fully connected network, a difference between the second influence prediction and the prediction influence label; and
updating parameters of the fully connected network based at least in part on the difference.

8. The method of claim 1, further comprising:
displaying, on a first graphical user interface associated with the proposed compute action, first indicator data indicating the predicted degree by which the proposed compute action is influenced by the past actions; and
receiving, by the communications hardware, a first control input causing execution of the proposed compute action.

9. The method of claim 1, further comprising sending, using the communications hardware, first data representing the influence prediction to a secondary device associated with the first user account.

10. The method of claim 1, wherein the proposed compute action is programmatically prevented from being executed by the at least one processor until an acknowledgement of the influence prediction is received from a device associated with the first user account.

11. The method of claim 1, wherein generating the first similarity score comprises:
clustering, by the at least one clustering engine, the first encoded data with the one or more encoded representations of the past actions associated with the first subset of the first plurality of user accounts; and
generating, by the outlier detection engine, the first similarity score based on the clustering.

12. A system comprising:
at least one clustering engine configured to determine, for a first user account, a first subset of a first plurality of user accounts as peers for the first user account;
communications hardware configured to receive a proposed compute action associated with the first user account;
an action encoder configured to generate first encoded data representing the proposed compute action;
an outlier detection engine configured to generate a first similarity score based at least in part on the first encoded data and one or more encoded representations of past actions associated with the first subset of the first plurality of user accounts; and
prediction circuitry configured to generate, based at least in part on the first similarity score, an influence prediction for the proposed compute action, the influence prediction indicating a predicted degree by which the proposed compute action is influenced by the past actions.

13. The system of claim 12, further comprising:
a demographic data encoder configured to:
receive first demographic data associated with the first plurality of user accounts, and
receive first user account demographic data associated with the first user account; and
the at least one clustering engine further configured to determine a first plurality of clusters of the first demographic data, wherein the first user account demographic data is associated with a first cluster of the first plurality of clusters, wherein the first cluster is associated with demographic data for the first subset of the first plurality of user accounts.

14. The system of claim 13, wherein:
the action encoder is further configured to determine a first set of past actions associated with the first user account;
the at least one clustering engine is further configured to determine a plurality of clusters of the first set of past actions; and
the outlier detection engine is further configured to determine that the proposed compute action is a statistical outlier with respect to the plurality of clusters.

15. The system of claim 14, wherein the outlier detection engine is further configured to generate the first similarity score based at least in part on the proposed compute action being the statistical outlier with respect to the plurality of clusters.

16. The system of claim 14, wherein the outlier detection engine is configured to determine an outlier prediction score, the prediction circuitry further comprising:
a fully connected network configured to generate the influence prediction using the first similarity score and the outlier prediction score.

17. The system of claim 16, wherein the prediction circuitry is further configured to:
receive training data comprising a second similarity score for a second proposed compute action, a second outlier prediction score for the second proposed compute action, and a prediction influence label;
generate, by the fully connected network, a second influence prediction using the second similarity score and the second outlier prediction score;
determine, by the fully connected network, a difference between the second influence prediction and the prediction influence label; and
update parameters of the fully connected network based at least in part on the difference.

18. A system comprising:
a means for determining, for a first user account, a first subset of a first plurality of user accounts as peers for the first user account;
a means for determining a proposed compute action associated with the first user account;
a means for generating first encoded data representing the proposed compute action;
a means for generating a first similarity score based at least in part on the first encoded data and one or more encoded representations of past actions associated with the first subset of the first plurality of user accounts; and
a means for generating, based at least in part on the first similarity score, an influence prediction for the proposed compute action, the influence prediction indicating a predicted degree by which the proposed compute action is influenced by the past actions.

19. The system of claim 18, further comprising:
a means for receiving first demographic data associated with the first plurality of user accounts;
a means for receiving first user account demographic data associated with the first user account; and
a means for determining a first plurality of clusters of the first demographic data, wherein the first user account demographic data is associated with a first cluster of the first plurality of clusters, wherein the first cluster is associated with demographic data for the first subset of the first plurality of user accounts.

20. The system of claim 18, further comprising:
a means for determining a first set of past actions associated with the first user account;
a means for determining a plurality of clusters of the first set of past actions; and
a means for determining that the proposed compute action is a statistical outlier with respect to the plurality of clusters.
